(19) United States
(12) Patent Application Publication
(10) Pub. No.: US 2006/0251412 A1
(43) Pub. Date: Nov. 9, 2006

(54) Zoom in/out system for a projection lens

(75) Inventor: I-Hsien Liu, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/417,117

(22) Filed: May 4, 2006

(30) Foreign Application Priority Data
May 6, 2005 (TW) 94118446

(51) Int. Cl. G03B 17/00

(52) U.S. Cl. 396/72

(57) ABSTRACT

A zoom in/out system includes a projection lens having a lens barrel and a set of lenses, an actuating rod disposed transversely within an axial slot in the lens barrel and connected operably to the lens set for co-movement therewith and extending outwardly from the lens barrel via the axial slot, a flat plate disposed on the lens barrel, an adjusting rod fixed on the flat plate for synchronous movement on the lens barrel in a direction perpendicular to an axial direction of the lens barrel, and a guiding groove formed on a lower surface of the flat plate, extending inclinedly relative to the axial direction for slidably enclosing the actuating rod therein. Synchronous movement of the adjusting rod and the flat plate to left and right sides of the lens barrel in the perpendicular direction results in movement of the actuating rod along the axial slot to adjust an image ratio of the projection lens.

### FIELD OF THE INVENTION

The invention relates to a zoom in/out system, and more particularly to a zoom in/out system for adjusting an image ratio of a projection lens within a projection apparatus.

### BACKGROUND OF THE INVENTION

A projection lens is used in order to assist in capturing an image or projecting the image onto a screen. The projection lens is generally fixed within an outer casing of the projection apparatus, and includes a lens barrel enclosing at least one lens set therein. A focus adjustment ring is disposed rotatably on the front end of the lens barrel to adjust a focus of the projection lens. A zoom in/out adjustment member is disposed on the barrel results in movement of the lens set, thereby varying an image ratio (generally called zoom in or out).

FIG. 1 shows a perspective view of a conventional zoom in/out system 4, and includes a projection lens having a lens barrel 2, an actuating rod 6, and a curved adjustment member 402. The lens barrel 2 encloses at least one lens set (not shown) therein and is formed with an axial slot 202. The actuating rod 6 is disposed transversely within the axial slot 202 in the lens barrel 2, and is operably fastened to the lens set.

The curved adjustment member 402 is mounted circumferentially on the lens barrel 2, and has a lower surface formed with a guiding groove 406 for slidably receiving the actuating rod 6 therein, and an upper surface formed with an adjusting rod 404 to facilitate a user for turning the adjustment member 402 with respect to the lens barrel 2.

Since the guiding groove 406 extends inclinedly with respect to the axial slot 202 in the lens barrel 2, rotation of the curved adjustment member 402 on the lens barrel 2 in the clockwise and counterclockwise directions results in adjusting an image ratio of the lens barrel 2.

It is relatively expensive to manufacture a mold having an inner curved portion for forming the curved adjustment member 402. In addition, once the conventional zoom in/out system is mounted within the outer casing (not shown) of the projection apparatus, the adjustment member 402 is disposed adjacent to a wall portion of the outer casing (not shown). Under this condition, a gap is formed between the wall portion and the adjustment member 402 due to the curve configuration of the adjustment member 402. A light may leak out from the outer casing via the gap. An extra cost will be resulted in case a light-shielding element is to be manufactured for shielding the abovementioned gap. Moreover, the guiding groove 406 is not formed circumferentially on the lens barrel 2 but rather extends in a direction transverse to the circumference such that the width of the guiding groove 406 may not uniform throughout the entire longitudinal length of the guiding groove 406.

### SUMMARY OF THE INVENTION

It is the object of the present invention to provide a zoom in/out system having components that can be constructed in simple ways due to their geometric structure so as to facilitate in manufacturing the mold for producing the components. The components thus manufactured provide a remarkable light shielding effect.

It is an another object of the present invention to provide a zoom in/out system having components occupying a little space on the lens barrel, which, in turn, provides a relatively large space for movement of the adjusting rod in a horizontal direction perpendicular to the axial direction of the lens barrel.

In one aspect of the present invention, a zoom in/out system is provided for adjusting an image ratio of a projection lens including a lens barrel and at least one set of lenses. The lens barrel is formed with an axial slot extending in a front-to-rear direction of the lens barrel. The zoom in/out system includes an actuating rod that is disposed transversely within the axial slot in the lens barrel and that is connected operably to the set of lenses for co-movement therewith. The zoom in/out system further includes a flat plate disposed on the lens barrel adjacent to the actuating rod, an adjusting rod fixed on an upper surface of the flat plate for synchronous movement on the lens barrel in a direction perpendicular to the front-and-rear direction, and a guiding groove formed on a lower surface of the flat plate, extending inclinedly relative to the front-to-rear direction for enclosing the actuating rod therein, wherein, synchronous movement of the adjusting rod and the flat plate to left and right sides of the lens barrel in the perpendicular direction due to an applied force results in movement of the actuating rod along the axial slot in the lens barrel so as to adjust of the image ratio.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of a conventional zoom in/out system;

FIG. 2 is a perspective and exploded view of a zoom in/out system of the present invention;

FIG. 3 is a fragmentary front sectional view illustrating an image ratio adjusted in the first embodiment of the zoom in/out system of the present invention;

FIG. 4 is a fragmentary front sectional view illustrating an image ratio adjusted in the first embodiment of the zoom in/out system of the present invention; and

FIG. 5 is a perspective and exploded view of the second embodiment of the zoom in/out system of the present invention.

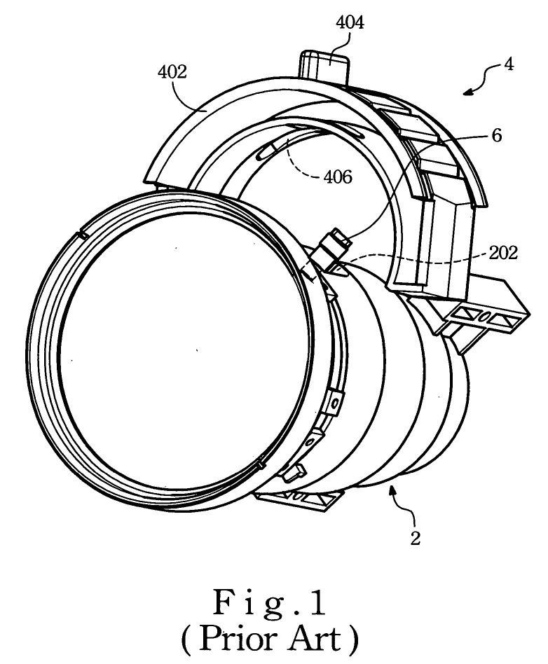

### DETAILED DESCCRIPTIONS OF THE PREFERRED EMBODIMENTS

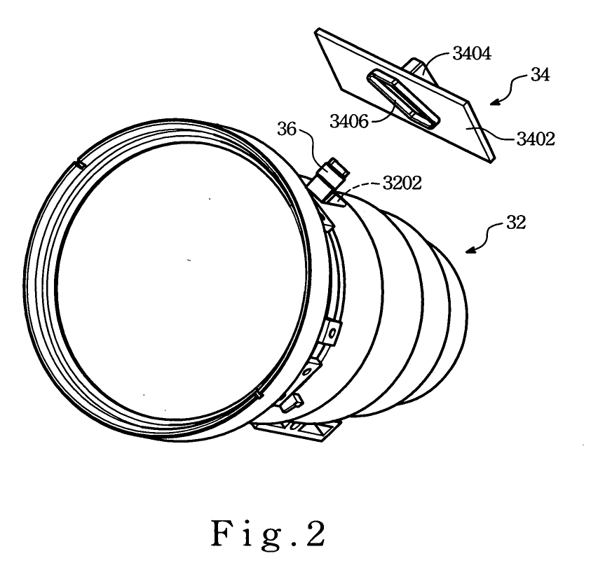

Referring to FIG. 2, a zoom in/out system 34 of the present invention is used in a projection apparatus (not shown) for adjusting an image ratio of projection lens including a lens barrel 32 and a set of lenses.

The lens barrel 32 is provided within an outer casing of the projection apparatus and is formed with an axial slot 3202 extending in a front-to-rear direction, and encloses a set of lenses therein. An actuating rod 36 is disposed transversely within the axial slot 3202 in the lens barrel 32, and has an inner end connected operably to the set of lenses (not shown) for co-movement therewith and an outer end extending outwardly from the lens barrel 32 via the axial slot 3202.

The zoom in/out system 34 according to the present invention includes a flat plate 3402, an adjusting rod 3404 and a guiding groove 3406. The flat plate 3402 is disposed on the lens barrel 32 adjacent to the actuating rod 36. The adjusting rod 3404 is fixed on an upper surface of the flat plate 3402 for synchronous movement on the lens barrel 32 in a direction perpendicular to the front-and-rear direction of the lens barrel 32.

The guiding groove 3406 is formed on a lower surface of the flat plate 3402, and extends inclinedly relative to the front-to-rear direction for enclosing the actuating rod 36 slidably therein such that synchronous movement of the adjusting rod 3404 and the flat plate 3402 to left and right sides of the lens barrel 32 in the perpendicular direction due to an applied force results in movement of the actuating rod 36 along the axial slot in the lens barrel 32 so as to adjust the image ratio.

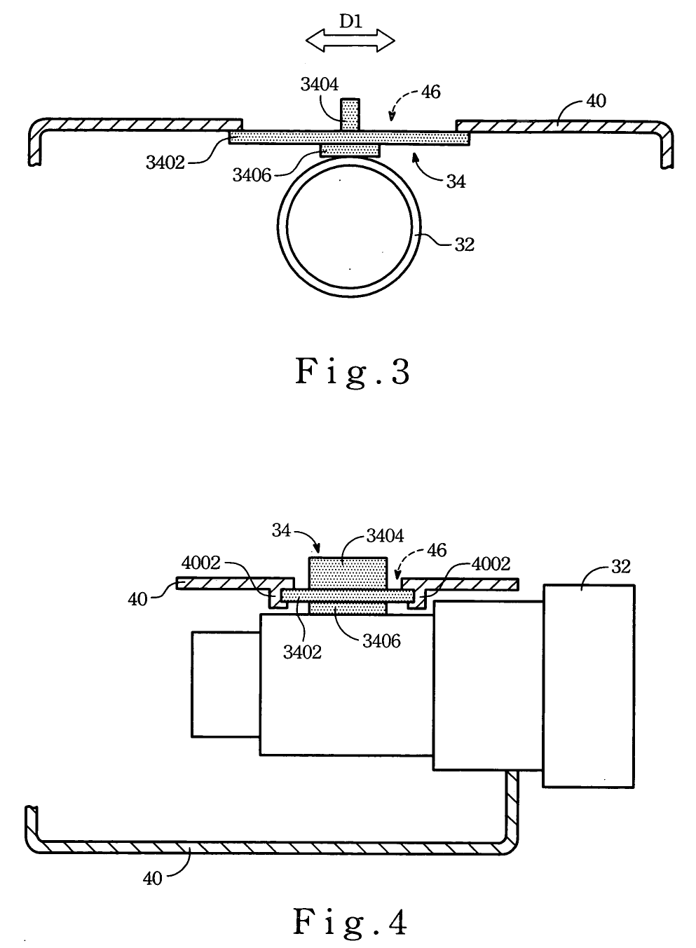

Referring to FIG. 3, the zoom in/out system 34 and the lens barrel 32 are enclosed by an outer casing 40 that has an upper wall formed with an upper opening 46 extending in the perpendicular direction. The outer end of the actuating rod 36 extends outwardly from the outer casing 40 via the upper opening 46 in the outer casing 40 to facilitate for moving the flat plate 3402 in the left and right sides of the lens barrels 32, as best shown by arrow D1.

Referring to FIG. 4, the upper wall of the outer casing 40 is preferably formed with a pair of sliding grooves 4002 extending along the upper opening 46. The flat plate 3402 has opposite front and rear sides received slidably in the sliding grooves 4002 to permit synchronous movement of the adjusting rod 3404 and the flat plate 3402 to the left and right sides of the lens barrel 32 in the perpendicular direction.

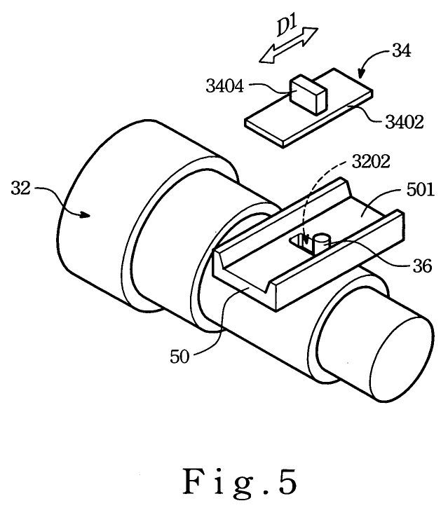

Refer to FIG. 5. The second embodiment is similar to the first embodiment in structure except that further includes a plate support 50. The plate support 50 is mounted fixedly on the lens barrel 32, and is formed with a lower opening extending in the front-and-rear direction to permit extension of the outer end of the actuating rod 36. The plate support 50 further defines a sliding groove 501 on an upper surface thereof. Under this condition, the flat plate 3402 is receiving slidably within the sliding groove 501 in the plate support 50. The flat plate 3402 is movable to the left and right sides of the lens barrel 32 along the arrow D1 so as to adjust the image ratio.

To summarize the above paragraphs, it is observable that it is relatively easy to construct the components (such as the flat plate 3402, the adjusting rod 3404, the outer casing 40 or the plate support 50) due to their geometric structure. Thus, molds for producing these components are easy to manufacture. In addition, the flat plate 3402 provides remarkable light shielding effect since it can be disposed in abutment with the outer casing of the projection apparatus. In contrast to the conventional zoom in/out system, once the flat plate 3402 is mounted on the lens barrel 32, it occupies a little space whereas the prior art adjustment member (being a curved configuration) occupied a relatively large amount of space. The adjusting rod 3404 moves in the perpendicular direction along a relatively long distance, thereby facilitating a user of the projection apparatus provided with the zoom in/out system of the present invention.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A zoom in/out system for a projection lens for adjusting an image ratio of the projection lens having a lens barrel and a set of lenses, the lens barrel being formed with an axial slot extending in a front-to-rear direction of the lens barrel, the zoom in/out system comprising:
an actuating rod disposed transversely within the axial slot in the lens barrel and connected operably to the set of lenses for co-movement therewith;
a flat plate disposed on the lens barrel adjacent to the actuating rod;
an adjusting rod fixed on an upper surface of said flat plate for synchronous movement on the lens barrel in a direction perpendicular to the front-and-rear direction; and
a guiding groove formed on a lower surface of said flat plate, extending inclinedly relative to the front-to-rear direction for enclosing the actuating rod therein, synchronous movement of said adjusting rod and said flat plate to left and right sides of the lens barrel in said perpendicular direction resulting in movement of the actuating rod along the axial slot in the lens barrel so as to adjust the image ratio.

2. The zoom in/out system according to claim 1, wherein the projection lens is used in a projection apparatus.

3. The zoom in/out system according to claim 1, further comprising a rectangular outer casing that encloses the projection lens and is formed with an upper opening extending in said direction perpendicular to the front-and-rear direction, the adjusting rod extending outwardly from the outer casing via the upper opening in the outer casing.

4. The zoom in/out system according to claim 3, wherein said outer casing is further formed with a pair of sliding grooves extending along said upper opening, said flat plate having opposite front and rear sides received slidably in said sliding grooves to permit synchronous movement of said adjusting rod and said flat plate to the left and right sides of the lens barrel.

5. The zoom in/out system according to claim 1, further comprising a plate support adapted to be fixed on the lens barrel, wherein the lens barrel is formed with a lower opening extending in the front-and-rear direction to permit extension of the outer end of the actuating rod and a sliding groove is formed on an upper surface of the plate support to receive said flat plate slidably in said sliding groove.
